(19) United States
(12) Patent Application Publication
(10) Pub. No.: US 2012/0048549 A1
(43) Pub. Date: Mar. 1, 2012

(54) Polymer Emulsions And Well Treatment Fluids

(75) Inventors: Dean Willberg, Tucson, AZ (US); Christopher N. Fredd, Westfield, NY (US); Vadim Kamilievich Khlestkin, Novosibirsk (RU); Denis Olegovich Menshikov, Minsk (BY)

(73) Assignee: Schlumberger Technology Corporation, Sugar Land, TX (US)

(21) Appl. No.: 13/147,089

(22) PCT Filed: Jan. 30, 2009
(86) PCT No.: PCT/RU2009/000037

§ 371 Date: Nov. 7, 2011

(51) Int. Cl. A47B 43/00; C09K 8/68

(52) U.S. Cl. 166/279; 507/211

(57) ABSTRACT

Some embodiments relate to oil and gas production, more specifically, to methods of controlling the condition of suspensions and fluids, small particle delivery and formation rock quality through controlled changes in the physical properties of a hydrolysable polymer contained in a treatment fluid.

### BACKGROUND

The statements in this section merely provide background information related to the present disclosure and may not constitute prior art. All documents cited hereinbelow are incorporated by reference thereto, in their entirety.

Some embodiments relate to oil and gas production, more specifically, to methods of controlling the condition of suspensions and fluids, small particle delivery and formation rock quality through controlled changes in the physical properties of the hydrolysable polymer comprised in the treatment fluid.

The technical solution provided herein comprises the use of an emulsion produced from a hydrolysable polymer (HP) or a non-hydrolysable polymer for various downhole operations such as proppant settling and sand production prevention, fluid loss and proppant production control and forming isolating or flow diverting barriers by initiating soft polymer settling from the injected emulsion.

Hydrolysable polymers (HP) are known as environmentally safe thermoplastics available in the form of films, powders or fibers. Typical examples of hydrolysable polymers are lactic acid polymer (PLA) or glycolic acid polymer (PGA) or other polyesters, plyorthoesters, polycarbonates and their mixtures and copolymers. These polymers are known to have downhole applications (in the form of fibers or powders) as materials contained in the liquid for the transport of proppants or mud loss preventing additions. Another form of polyester delivery to the well can be polymer emulsion.

PLA emulsion preparation procedure was disclosed in PCT/IB2007/054455 (Willberg et al.). Methods of destructing (destabilizing) hydrolysable polymer emulsions were also disclosed therein.

It was shown in Patent Application PCT/IB2007/054455 that an acid precursor (e.g. PLA) can be dissolved in a safe organic solvent and then transferred to water emulsion. It was also shown in that invention that PLA and other solid acid precursors can be used for the acid treatment of the well formation rock by acid generation due to the hydrolysis of the source polymer material.

However, emulsions of polyester class polymers have greater potential for downhole applications. For example, the technical solution provided herein comprises the use of PLA emulsion for the production of fully or partially impermeable barriers in the well as well as a mud loss preventing addition.

The object of this invention is to provide controlled hydrolysis of a hydrolysable polymer emulsion using various destabilizing factors such as heat, chemicals and strongly developed surfaces. The exposure to destabilizing factors causes the hydrolysable polymer to settle in the form of sticky drops. This property has several downhole applications. It is suggested to achieve this technical solution by preparing a hydrolysable polymer emulsion and decompose the emulsion while producing temporary sticky polymer film or another form, if necessary. Existing technical solutions for various applications of the technical solution provided herein are described below.

Well Interval Isolation and Flow Diverting

The object and application of reversible isolation (or flow diverting) of a well interval were described in Patent Application WO2007066254(A2) ‘Hydrolysable Material for Water Diverting and Isolation Purposes (Willberg, Bulova, Fredd et al.) as a technology of producing barriers with hydrolysable polymer fibers. Also known is the use of these fibers as mud loss preventing additions (U.S. Pat. No. 7,275,596 B2 (Willberg, Fredd, Bulova) ‘Method of using Degradable Fibers for Stimulation’).

That patent described the use of said fibers for the transportation, suspending and placement of proppant or gravel in viscous liquids for hydraulic fracturing if the viscosity of the liquid is insufficient to prevent solid particles from settling. The invention also described proppant transportation optimizing fibers capable of hydrolyzing, after the completion of operation, to natural products that do not settle in water solutions in the presence of ions such as calcium and magnesium. Cross-linked polymer liquids were separated that are not damaged by the components present in those fibers.

However, providing a high-quality downhole barrier remains a problem. The permeability of barriers in casing string perforations or near the bottomhole bed still depends on injection parameters, and zero permeability of fiber barriers is unlikely to be feasible within the prior art methods.

Known is a method of controlling sand production with simultaneous formation of a temporary barrier when producing hydraulic fractures (Ali S., Norman D., et al, Combined Stimulation and Sand Control, Oilfield Review, vol. 14, No. 2, pp. 30-47). HP emulsions can be used for this purpose when implementing the technical solution provided herein. Using that emulsion of a hydrolysable polymer or its solution providing an amorphous polymer residue will reduce the barrier permeability.

Controlling Small Particle, Sand and Proppant Production and Formation Rock Permeability

Solid particle migration control is of great importance for efficient well operation. Small solid particles may form residues to damage equipment and contaminate the bottomhole zone which has a negative effect on oil production rate. Multiple solutions have been suggested to address this problem, but most of the solutions have serious limitations or are only suitable for special downhole environments.

Sand production causes equipment erosion damage, clogs piping and produces underground cavities, while the sand so produced requires separation and disposal on the ground (Carlson J., Gurley D., et al., Sand Control: Why and How, Oilfield Review, vol. 4, No. 4, 1992, pp. 41-53; Armentor R. J. et al., Regaining Sand Control, Oilfield Review, vol. 19, No 2, pp. 1-13, 2007). Sand production reduction methods include thorough pressure difference and flow rate control, installation of a slotted extension pipe, installation of filters or resin-coated gravel packs and other technologies.

For example, U.S. Pat. No. 4,811,790 discloses a method and a device for particle removal from well fluid at low pH and high temperatures. The method comprises the use of a cylindrical holder with one end open and the other end closed. Said holder comprises the inner and the outer walls connected at the closed end to form an annular space. Said annular space contains a porous refractory tube. Said holder is fixed to a transport tube lowered into the formation rock. Said porous tube is used for the control of small particles and sand migrating with the fluid produced from the formation rock. The refractory tube held between the walls easily withstands the stresses and can be easily removed for cleaning. The tube is chemically inert and withstands high temperatures inherent to steam heating applications or steam injection in oil industry.

U.S. Pat. No. 5,775,425 describes a method of treating an oil producing well with a treatment fluid for preventing or reducing small particle production. The method comprises the preparation of a liquid suspensions with sticky material coated particles, injection of that suspension into a formation and suspension placement in the formation such that said sticky material hinders the migration of small particles during the production of fluids from the formation. In another embodiment, said sticky component can be delivered to the formation rock in the form of a diluted solution and then settled onto earlier injected suspended particles to prevent the migration of the suspended particles and the production of small particles with hydrocarbons from the adjacent rock.

The use of a sticky material for proppant pack strengthening was disclosed in U.S. Pat. No. 7,131,491. The patent described a method of producing a proppant pack in a formation fracture comprising the introduction, into the formation fracture, of a special liquid containing proppant particles at least partially coated with a water based sticky material with further activation of the sticky material and the formation a proppant pack. The sticking material activator can be chosen from a group containing acids, salts, anhydrides or surfactants. However, the preparation of that proppant with special coating increases the cost of the pack strengthening operation.

Patent Application WO2006/136031 described a clay stabilizer in the form of a combination of two or more amine salts capable of cationic exchange; the reactants have different molecular weights, molecular structure and ionic power and therefore can act as clay swelling preventing reactants regardless of clay composition in the formation rock. Moreover, the clay stabilizer can restore the rock permeability earlier impaired by the injection of improper water media and water based liquids.

U.S. Pat. No. 5,226,495 relates to the control of small particle production with hydrocarbons from reservoirs, more specifically, to the control of small particle production from reservoirs with heavy oil during formation heat treatment and for tilt wells.

Fluid Loss Control

Fluid loss control is an important procedure in formation hydraulic fracturing. This parameter depends on the viscosity and cake forming properties of the hydraulic fracturing liquid and the permeability and porosity of the formation. If the permeability and porosity of the formation are high, fluid loss is controlled by increasing the viscosity or the cake forming properties of the hydraulic fracturing liquid by adding polymers or appropriately sized particles (Hanna B., Ayoub J., Cooper B., Rewriting the Rules for High-Permeability Simulation, Oilfield Review, vol. 4, no. 4, 1992, pp. 18-23).

Fluid loss control additions may vary. For example, U.S. Pat. No. 3,898,167 describes additions comprising oil-soluble resins, either hard or elastic. Fluid loss control additions may be fibers such as in U.S. Pat. No. 7,275,596 (Fredd et al.). In Patent U.S. Pat. No. 7,096,947, fluid loss to the formation rock is prevented by using additions with a deformable and hydrolysable material.

Proppant Placement

Proppant particle placement remains a pressing problem in hydraulic fracturing. Knowing proppant settling rate is required for predicting the final proppant distribution in the fracture. Profound understanding of the proppant delivery mechanism during hydraulic fracturing planning helps in obtaining a more efficient distribution of injected proppant (McMechan, et al., SPE Production Engineering, 1991, v.6, n.3, pp. 305-312).

Fiber technologies have been suggested to control proppant settling rate (US 2006/0283591A1, D. Willberg, et al), as well as ultralight proppants and other methods.

Unlike a standard Newtonian liquid where proppant settling is described by the Stokes law, fibers added to a proppant suspension change the settling pattern dramatically. This type of settling is referred to as Kinch settling. An advantage of Kinch settling is that the viscosity of the settling liquid has smaller effect on the settling rate. Addition of even low fiber concentration (0.5-5%) reduces the settling rate by one order of magnitude. Therefore, the matrix liquid viscosity requirement is also one order of magnitude lower. This effect is the basis of the FiberFRAC technology (C. H. Bivins et al., New Fibers for Hydraulic Fracturing, Oilfield Review, Summer 2005, pp. 34-43).

The small particle, sand and clay flow, liquid loss and proppant placement control methods described in the patent typically require special equipment, preliminary modification of the proppant or holding the operation at pH and ionic composition and in special media.

The general approach to suspended particle control used in the technical solution disclosed herein is based on the decomposition of a polymer emulsion due to exposure to a destabilizer to form soft sticky polymer in the downhole environment. Further slow hydrolysis of the settled polymer allows restoring the permeability of the treated interval which is important for efficient hydrocarbon production.

The use of activators for the initiation of various processes during well treatment is well known (B. Todd, et al., A Chemical Trigger Useful for Oilfield Applications, SPE 92709, 2005, pp. 1-7). A classical example of a delayed reaction is the use of gel destructors in hydraulic fracturing liquids (for viscosity reduction). Acids, oxidizers or ferments are commonly used for polymer destruction and the mitigation of the rock damage caused by viscous polymer. Filtering cake cleaning can be delayed. The delayed acid release systems described in the cited article were based on orthoesters in combination with alkaline inhibitors that were tested as delayed destructors.

The object of this technical solution is to provide new downhole technologies for increasing hydrocarbon production.

### SUMMARY

It is suggested to achieve said object using a method of downhole operations comprising the injection of a hydrolysable polymer water emulsion into the well, destruction of said emulsion in the downhole environment and settling of a sticky amorphous polymer on the formation rock or other surfaces. The method provided herein can be used for forming barriers for isolation, flow diverting, rock permeability reduction or fluid loss control. This list does not limit the possible application of the technical solution disclosed herein.

The object can also be achieved using a method of downhole operations comprising the injection of organic solutions of hydrolysable polymers into the well, hydrolysis of the polymers and settling of a sticky amorphous polymer on the formation rock or other surfaces. The method provided herein can also be used for forming barriers for isolation, flow diverting, rock permeability reduction or fluid loss control. The method is implemented using organic solutions of polylactic acid, polyglycolic acid, their copolymers and other polymers hydrolysable in the downhole environment. This list of substances does not limit the possible application of the technical solution disclosed herein.

Also, the object can be achieved using a method of destructing a hydrolysable polymer water emulsion to form an amorphous hydrolysable polymer comprising the exposure of said water emulsion to multivalent cations or a developed surface and changing the emulsion temperature. In some cases, the solution of multivalent cations is injected separately or generated in the treated rock, for example, said solution of multivalent cations is generated by acid treatment of the rock. Emulsion is typically delivered to the well through flexible production strings, and the solution of multivalent cations is injected through the annular space; however, emulsion can be injected into the well through the annular space and the solution of multivalent cations can be delivered through flexible production strings. Sometimes, the hydrolysable polymer emulsion is delivered to the well along with the proppant by preliminarily spraying the emulsion onto the proppant. Hydrolysable polymer emulsion can also be delivered the well along with the treatment fluid. In some embodiments, hydrolysable polymer emulsion is delivered to the well by portions. Emulsion portions are sometimes modified by a destabilizer. In some embodiments, hydrolysable polymer emulsion is delivered to the well through a separate line during hydraulic fracturing simultaneously with fibers, proppant and destabilizer, preferably, through a flexible production string.

Another way to achieve the object is to use a method of delivering a delayed emulsion destabilizer where the destabilizer is delivered to the well in the form of a slowly soluble calcium or magnesium salt, encapsulated salt or wax or oil coated salt crystals.

Yet another way to achieve the object is to use a method of delivering a polymer to the well where the polymer emulsion is injected into the well before, after or simultaneously with the emulsion destabilizer or simultaneously with the treating suspension.

The technical solution provided herein describes the use of emulsions and solutions, preferably PLA (polylactic acid), PGA (polyglycolic acid), PLA/PGA copolymers, other hydrolysable and non-hydrolysable polymers and their mixtures for reducing barrier and rock permeability and controlling the migration of liquids, small particles and sand and proppant placement. The polymer emulsion is destructed by exposing to developed surfaces, changing temperature and exposing to chemicals (in this context, substances reducing the stability of emulsion drops and causing polymer settling from the emulsion) in the presence or in the absence of fibers, aimed at forming more or less permeable barriers, coatings or films of a soft hydrolysable polymer (HP). Moreover, the polyesters settled from the emulsion are amorphous (soft) polymers that are more susceptible to rapid hydrolysis than crystalline powders or fibers of the same material. Thus, the conductivity of the treated interval increases, and more acid will release from the amorphous material during the same time period.

HP emulsions can form barriers, films or coatings from polymers or in combination with fibers or other solid particles (grains, balls, proppant, chips etc.).

Varying the content of the polymer material (using copolymers, polymer mixtures and other compositions) when preparing the emulsion (solution), one can control the hydrolysis time of the settled polymer and improve the surface adhesion after polymer settling.

### BRIEF DESCRIPTION OF THE DRAWINGS

The manner in which the objectives of some embodiments and other desirable characteristics may be obtained is explained in the following description and attached drawings in which:

FIG. 1A and FIG. 1B illustrate changes in the proppant suspension;

FIG. 3 shows the result of the test where the initial sample pressure drop curve, the PLA emulsion injection is completed, and the growing pressure difference indicates a decrease in the permeability and barrier formation.

### DETAILED DESCRIPTION

At the outset, it should be noted that in the development of any such actual embodiment, numerous implementation-specific decisions must be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the composition used/disclosed herein can also comprise some components other than those cited. In the summary and this detailed description, each numerical value should be read once as modified by the term “about” (unless already expressly so modified), and then read again as not so modified unless otherwise indicated in context. Also, in the summary and this detailed description, it should be understood that a concentration range listed or described as being useful, suitable, or the like, is intended that any and every concentration within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors possessed knowledge of the entire range and all points within the range. Various embodiments of the technical solutions provided herein will be described below. It will be evident for those skilled in the art that various modifications of these embodiments are possible.

The technical solution provided herein is based on the use of a water emulsion comprising at least one polymer hydrolysable in the downhole environment, where the water emulsion is in the form of an organic phase dispersed in the water phase, and where the organic phase contains the polymer hydrolysable in the downhole environment, an organic solvent of the polymer (possibly, also hydrolysable in the downhole environment), an emulsifier, a viscosity controller and at least one stabilizer. One method of obtaining said water emulsion comprises slow dissolution of said solid hydrolysable polymer in said organic solvent at a temperature that is typically above the polymer glass transition point, cooling of the solution at a temperature from about 20 to about 40° C., preparation of the treatment fluid in a separate blender with the addition of an efficient quantity of a surfactant, and the addition of the hydrolysable polymer solution to the treatment fluid with sufficiently intense stirring for the production of a stable emulsion. In some cases, the polymer dissolved in the organic solvent can be preliminarily hydrolyzed to the desired viscosity. As necessary, emulsion stabilizers can be added to the treatment fluid. In some instances, the hydrolysable polymer is selected from the group containing lactic acid polymers, glycolic acid polymers, their copolymers and mixtures. Typically, the solvent for the class of hydrolysable polymers is selected from a group of solvents having low volatility, low toxicity, high inflammation temperature and degradable in the downhole environment. Often, a solvent is used with a vapor pressure of less than about 3 to about 6 Pa at 20° C. and a flammability temperature of greater than about 90° C. Typically, the solvent pertains to the class of dibasic esters (DBE): DBE-4, DBE-5, DBE-6 and their mixtures. Typically, the emulsifier is a cationic, anionic or nonionic surfactant. In some instance, the fluid is emulsified in a high-speed disperser, a spray injector or a field blender. Typically, the stabilizer and the surfactant are added to the water phase. The emulsion stabilizer may be selected from a group containing polymers, fine powders, fibers and chemical reactants. Also, gelatin may be used as the emulsion stabilizer. The polymer may be selected such that its hydrolysis in the downhole environment produces a sticky polymer material, and the downhole hydrolysis may be irreversible.

Proppant Control

Sticky polymer droplets released from the HP emulsion can be used for bonding other materials, e.g. fibers, into a random 3D mesh. This embodiment may have various applications.

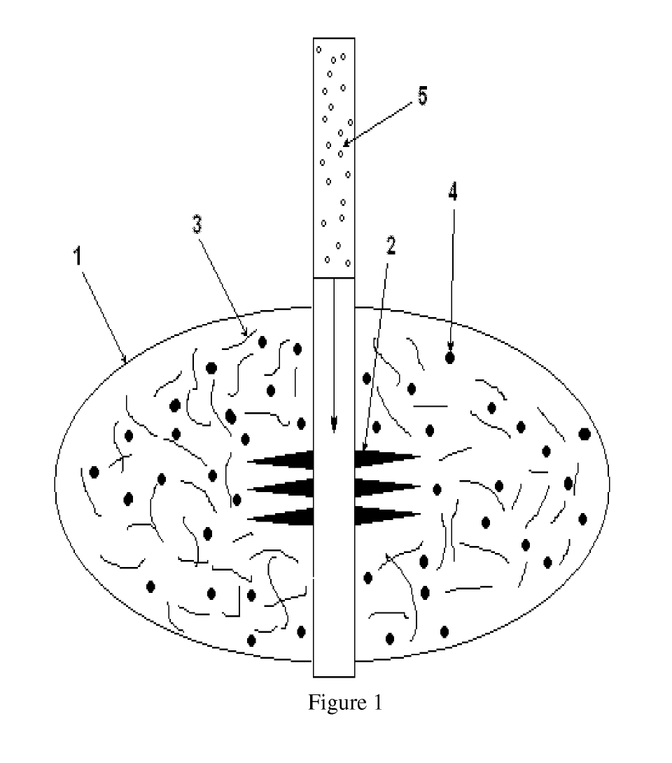

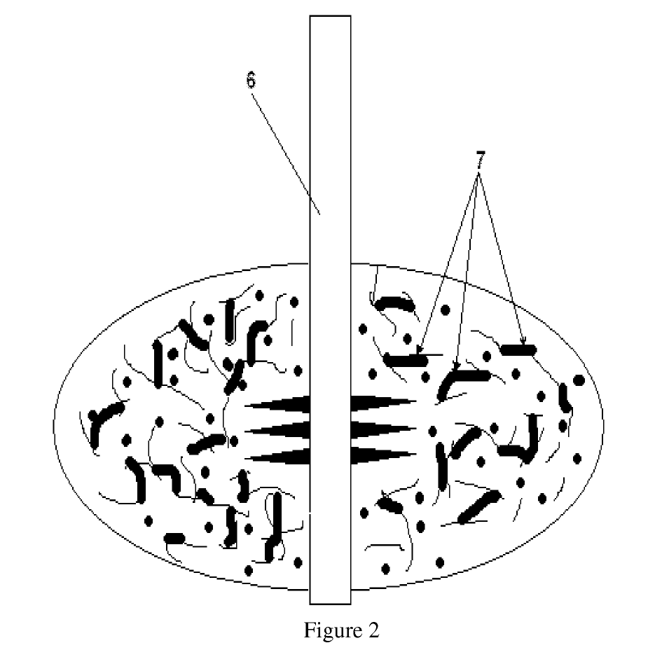

One application of this process is efficient proppant retention in the carrier liquid. Fibers dispersed in guar gel (or another water based fluid) may form a 3D mesh after PLA water emulsion decomposes in critical conditions (FIG. 1). The initial mixture of the emulsion with dispersed polymer fibers transforms to a mesh of fibers bonded with one another by the amorphous PLA drops released due to emulsion destruction. The proppant particles may be securely held by the 3D mesh. This technology is applicable both for conventional proppants and for polymer coated proppants.

The changes in the proppant suspension are illustrated in FIG. 1A and FIG. 1B. FIG. 1B illustrates the overall suspension behavior after the activator initiated the destruction of the emulsion droplets. The notations in FIGS. 1A and 1B are as follows: (1) hydraulic fracture in the formation, (2) casing string perforations, (3) suspended fibers, (4) proppant particles, (5) hydrolysable polymer emulsion injected into the treatment zone, (6) well for delivering the suspension and the emulsion and (7) soft sticky polymer particles released after emulsion destruction and having strong adhesion to other suspended solid particles.

The proppant settling rate was assessed using a simple test in measuring cylinders (Example 2), and a dramatic decrease in the proppant settling rate was found after the reaction completed (it was close to zero under the test conditions).

It is promising to use emulsions of lower molecular weight and amorphous structure polymers. In that embodiment, the hydrolysis rate of this HP modification should be higher and the proppant pack permeability restores faster.

Moreover, the low loading of the fibers and the gelling agent combined with process starting only after the delivery of the material allow injecting the propping material at lower pressure difference in the delivery pipelines.

Thus, the advantages of the HP emulsion technology for controlled proppant placement are as follows:
1. Lower proppant settling rate;
2. Lower loading of the degrading polymer and the gelling agent;
3. Faster polymer degradation in the rock; and,
4. Lower pressure drop during injection of working fluids.

Proppant Loss Control

The formation of a random 3D mesh from polymer fibers can also be used for proppant loss prevention and gives a more uniform proppant pack in complex-shaped fractures. For example, proppant loss is reduced by injecting fibers at final stages of hydraulic fracturing followed by emulsion destruction and partial bonding of the fibers to form a 3D mesh further retaining the proppant. The type of polymer hydrolysis depends on HP type and can be selected based on the proppant loss control requirements. The polymer used for this purpose can be selected from a class of polymers used in the downhole environment or stable polymers.

Small Particle Migration Control and Rock Consolidation

Hydrolysable or stable polymer emulsions can be used for forming polymer films for temporary or permanent control of small particle migration or clay sensitivity. For example, PLA emulsion composition can be obtained such that it will destabilize (triggers) when exposed to aluminum silicate or carbonate minerals in the formation to form a thin PLA film on the rock surface. This film will also act as a barrier for cationic exchange in liquid leaking clays thus preventing the swelling and migration of clay minerals. Polymers used for this purpose should be stable in the downhole environment.

Polymer emulsions can be used for binding rock grains in loosely consolidated formations. In this embodiment, the composition of the polymer emulsion injected into the well causes emulsion destruction in the bottomhole zone with the rock particles being bound by the released polymer into a more stable structure. Polymers used for this purpose can be stable in the downhole environment.

Forming Degradable Polymer Surface Films

PLA and other hydrolysable polymer emulsions are very suitable for forming low permeability barriers not only in the bulk of the proppant pack, but also on the rock surface. In that embodiment, emulsion decomposition can be initiated by an increase in temperature or by surface capillary effects, or by a chemical injected before, during or after emulsion delivery; moreover, the chemical can be a natural constituent of the formation rock (e.g. ions in the country liquid).

Acid treatment of carbonate rocks may cause emulsion destruction by calcium salts and polymer settling in the form of sticky amorphous material. This reduces rock permeability and thus liquid loss to the rock, and also diverts the path of the acid treatment fluid.

Deposition of a PLA surface film can be used for liquid loss control or during rock acid treatment. PLA emulsion behavior depends on the surface type. For example, PLA emulsion may wet sandstone (Ohio) and carbonates to form thin organic films. The resultant PLA films have low water permeability [Hideto Tsuji, Rumiko Okino, Hiroyuki Daimon, Koichi Fujie, Mechanical, Physical and Barrier Properties of Poly(Lactide) Films, Journal of Applied Polymer Science, Vol. 99, 2245-2252 (2006); Rafael A. Auras, Bruce Harte, Susan Selke and Ruben Hernandez, Journal of Plastic Film and Sheeting, vol. 19, p. 123-135], and therefore films are used for downhole liquid loss control (the reference is only about the low permeability of the film).

PLA does not settle on the metallic surfaces of pipes in the well and in the pumps. PLA emulsion remains stable when exposed to PTFE or other plastic surfaces. The emulsion stability period may be controlled by addition of stabilizers.

Isolation and Liquid Flow Diverting Barriers

Polymers (hydrolysable or stable) can be injected into the well for forming an isolation barrier in the casing string perforations or forming a diverting barrier in wormholes or fractures near or far wellbore.

Emulsion can be injected before, after or mixed with the suspension. The liquid suspension may contain fibers, powder, bubbles and various particles, e.g. solid, liquid or gaseous. These additions may either stabilize or destabilize the emulsion.

This embodiment of the technical solution provided herein is illustrated by example 3 and in FIG. 2.

Barrier formation is illustrated by the curves in FIG. 2 denoted as follows: (1) the low pressure drop curve (the impermeable barrier is not yet formed), (2) polymer emulsion injection and (3) pressure difference in the cell increases to indicate a decline in the sample permeability (barrier formation).

A destabilizer for polymer emulsion can be delivered before, after or simultaneously with the emulsion.

Depending on rock composition, the destabilizer can be contained in the rock itself, be a rock temperature factor or be the multivalent ions dissolved in the downhole fluids.

### EXAMPLE 1

A simplest test for proppant retention power of a suspension was made in a standard glass beaker with a mixer. Several ml of prepared 10% PLA water emulsion was added to 80 g suspension consisting of guar gel, 10 g/l PLA fibers, 240 g/l BorProp 20/40 proppant and low salt concentration (KCl or CaCl₂, 0.5-2%). The best results were obtained for the addition of 3 ml of 10% emulsion and 2% CaCl₂ emulsion destructor.

After the reaction, randomly oriented fibers bind with one another due to the contact with the sticky and soft polymer species; the proppant particles are captured by the suspended mesh of the fibers and exhibit very slow settling rate.

### EXAMPLE 2

Proppant settling rate was measured for the following suspension samples (viscous liquids with suspended solid particles) with the addition of a strong emulsion destructor (CaCl₂):
Glass beaker 1: guar gel+10 g/l PLA fibers+240 g/l Fores 16/20 proppant+20 g/l KCl+1.4 g/l CaCl₂;
Glass beaker 2: guar gel+10 g/l PLA fibers+240 g/l Fores 16/20 proppant+20 g/l KCl+1.4 g/l CaCl₂+50 g/l 10% PLA water emulsion;
Glass beaker 3: guar gel+5 g/l PLA fibers+240 g/l Fores 16/20 proppant+20 g/l KCl+1.4 g/l CaCl₂+50 g/l 10% PLA water emulsion.

In the glass beaker without emulsion (No. 1), proppant 100% has settled in a few hours. In the measuring glasses with decomposed polymer emulsion (Nos. 2 and 3), there was no visible proppant settling even after the period of 10 days.

The total PLA concentration (PLA fibers and PLA emulsion) in glass beaker No. 2 is 10 g/l+50×0.1 g/l=15 g/l. The total PLA concentration in glass beaker No. 3 is 5 g/l+50×0.1 g/l=10 g/l. The proppant settling rate in these two glass beakers is very low and almost the same. It can be seen that the total PLA concentration in glass beaker No. 1 without emulsion (only the fibers) is 10 g/l. That is, the fibers themselves in the tested concentration range (5-10 g/l) cannot affect the proppant settling rate. Therefore the operator may reduce fiber and polymer loading without compromising the proppant settling rate.

### EXAMPLE 3

Isolating barrier formed in a perforation was tested in a standard rock sample and a sample crack tester used in geophysical survey. The test cell, valves and pressure gages were designed to track the system pressure and measure the liquid flow through the cell.

180 ml suspension (guar gel+12 kg/m³ fibers+2% KCl+2% CaCl₂) was delivered with an ISCO pump at a gradually increasing flow rate via a 1.3 cm diameter steel pipe through a 100 mesh pipe end strainer. The small cell mesh simulated a permeable barrier formed by the settlement of filtering components on a perforation (sand, gravel, polymer fibers and mixtures thereof). The object of the test was to transform the highly permeable barrier to a low permeable one.

At an early test stage, unfiltered fibers collect on the mesh to form a permeable barrier cake. Then the liquid flow rate is reduced and 2 ml of 10% PLA emulsion is added (10% PLA, 40% dibasic ester mixture solvent and 50% guar gel). This immediately produces a high pressure drop (from 0.07 to 0.4 MPa) indicating the formation of an impermeable cake on the mesh (FIG. 2).

In this example the emulsion destabilizer was added to the suspension and into the pore space of the barrier before injecting the polymer emulsion; so the emulsion looses intactness in the Ca²⁺ rich media arranged in the test cell.

The solid line in FIG. 2 shows the change in the test cell pressure (the pressure is on the right-hand vertical axis in Pa). The dashed line shows the behavior of liquid flow rate (ml/min on the left-hand vertical axis).

### EXAMPLE 4

The tests were carried out in the same arrangement as in Example 3, but the test procedure simulated a decrease in the pack permeability through the treatment zone (formation of a flow diverting barrier). The treatment zone was a sample of Badger coarse-grained sand reinforced with polymer fibers.

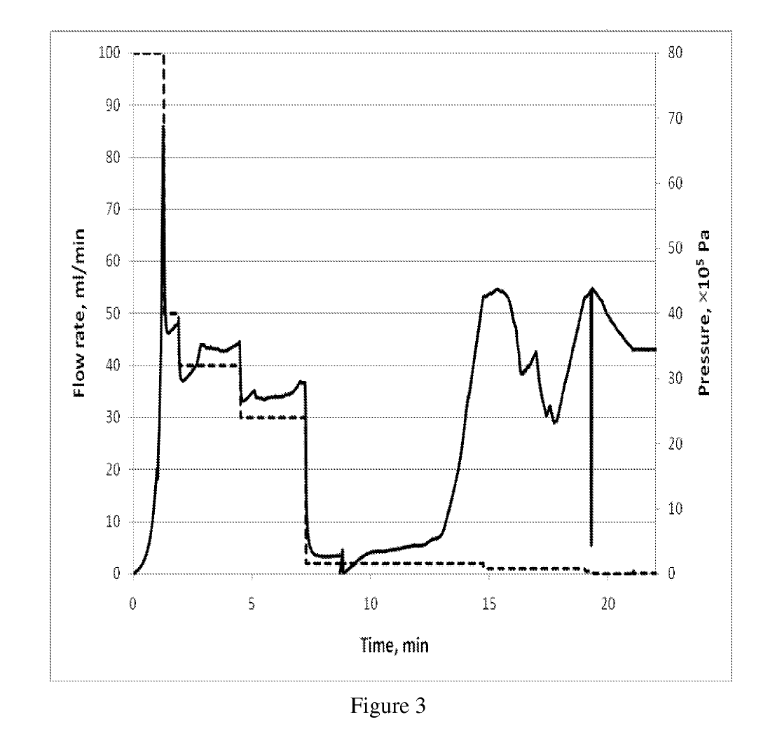

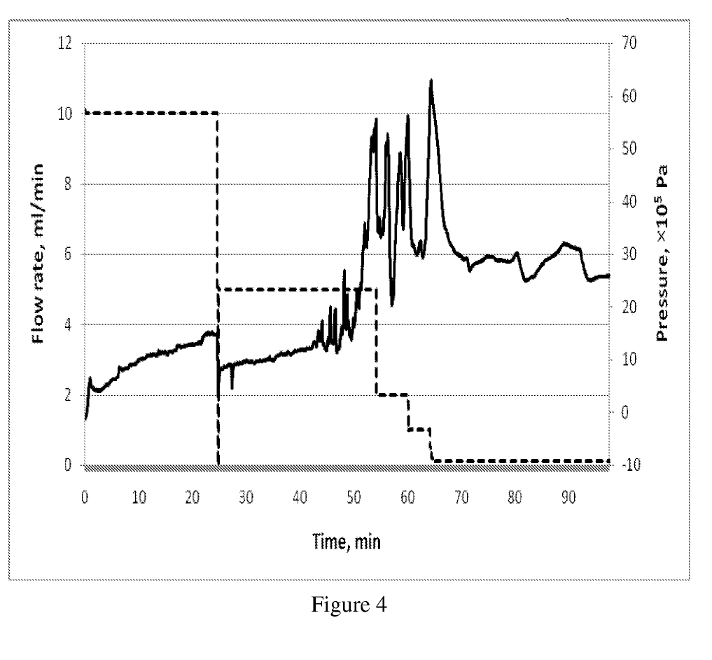

The impermeable barrier was formed by injecting emulsion containing 10% PLA to guar gel with 2% CaCl₂; the emulsion was injected through a badger sand proppant pack with PLA fibers (the result is shown in FIG. 3). A similar barrier can be formed without fibers in the pack by increasing the PLA emulsion concentration.

In this example, the emulsion destabilizer was Ca²⁺.

FIG. 3 shows the result of the test where (1) is the initial sample pressure drop curve (the barrier is not yet formed), (2) the PLA emulsion injection is completed and (3) the growing pressure difference indicates a decrease in the permeability and barrier formation (high pressure with zero flow).

What is claimed is:

1. A method comprising injection of a hydrolysable polymer water emulsion into the well, destruction of the emulsion in the downhole environment, and settling of a sticky amorphous polymer on formation surfaces.

2. The method of claim 1 wherein the sticky amorphous polymer is settled for forming barriers for isolation or flow diverting.

3. The method of claim 1 wherein the sticky amorphous polymer is settled for rock permeability reduction.

4. The method of claim 1 wherein the sticky amorphous polymer is settled for fluid loss control.

5. A method comprising injection of organic solutions of hydrolysable polymers into the well, hydrolysis of the polymers, and settling of a sticky amorphous polymer on the formation rock surface.

6. The method of claim 5 wherein the method is implemented using organic solutions of polylactic acid, polyglycolic acid, their copolymers and other polymers hydrolysable in the downhole environment.

7. The method of claim 5 wherein the sticky amorphous polymer is settled for forming barriers for isolation or flow diverting.

8. The method of claim 5 wherein the sticky amorphous polymer is settled for rock permeability reduction.

9. The method of claim 5 wherein the sticky amorphous polymer is settled for fluid loss control.

10. A method of destructing a hydrolysable polymer water emulsion to form an amorphous hydrolysable polymer comprising the exposure of the water emulsion to at least one of multivalent cations, a developed surface, or a change in the emulsion temperature.

11. The method of claim 10 wherein the solution of multivalent cations is injected separately or generated in the treated rock.

12. The method of claim 11 wherein the solution of multivalent cations is generated by acid treatment of the rock.

13. The method of claim 10 wherein the emulsion is delivered to the well through flexible production strings, and the solution of multivalent cations is injected through the annular space.

14. The method of claim 10 wherein the emulsion is injected into the well through the annular space and the solution of multivalent cations can be delivered through flexible production strings.

15. The method of claim 10 wherein the hydrolysable polymer emulsion is delivered to the well along with the proppant.

16. The method of claim 10 wherein the hydrolysable polymer emulsion is delivered to the well along with the treatment fluid.

17. The method of claim 10 wherein the hydrolysable polymer emulsion is delivered to the well by portions.

18. The method of claim 17 wherein the emulsion portions are modified by a destabilizer.

19. The method of claim 10 wherein the hydrolysable polymer emulsion is delivered to the well through a separate line during hydraulic fracturing simultaneously with fibers, proppant and destabilizer.

20. The method of claim 19 wherein the emulsion is delivered through a flexible production string.

21. A method of delivering a delayed emulsion destabilizer wherein the destabilizer is delivered into a well in the form of a slowly soluble calcium or magnesium salt, encapsulated salt, wax coated salt crystals, or oil coated salt crystals.

22. A method of delivering a polymer into well, wherein the polymer emulsion is injected into the well before, after or simultaneously with the emulsion destabilizer or simultaneously with the treating suspension.
